(19) United States
(12) Patent Application Publication
(10) Pub. No.: US 2002/0165767 A1
(43) Pub. Date: Nov. 7, 2002

(54) Advertisement system

(76) Inventors: Kazuhiro Ogura, Kawasaki-shi (JP); Akinori Iwase, Yokosuka-shi (JP); Tatsuya Haraguchi, Yokohama-shi (JP)

Correspondence Address: Johnny A. Kumar, FOLEY & LARDNER, Washington Harbour, 3000 K Street, N.W., Suite 500, Washington, DC, 20007-5109, US

(21) Appl. No.: 09/845,258

(22) Filed: May 1, 2001

(51) Int. Cl. G06F 17/60

(52) U.S. Cl. 705/14

(57) ABSTRACT

An advertisement of merchandise is displayed, and an e-mail message of information of the piece of merchandise, including link information capable of linking with a site where the piece of merchandise is on sale, is transmitted to a user who has an interest in the displayed a piece of merchandise. The time required of the user to purchase the piece of merchandise can be shortened, the piece of merchandise can be examined and purchased by simple operation, and the advertisement effect can be improved.

### BACKGROUND OF THE INVENTION

The present invention relates to an advertisement system which displays an advertisement on a customer display device prepared in, e.g., an automatic vending machine, digital copying machine, or a cash register of a POS system.

Conventionally, a common advertisement apparatus as an advertisement system displays an advertisement on a customer display device seen by a plurality of users. For example, Jpn. Pat. Appln. KOKAI Publication Nos. 6-333159 and 10-214383 describe systems that display an advertisement on a customer display device arranged on a cash register in a POS system. Some advertisement systems display an advertisement on a customer display device such as a customer display device installed in an automatic vending machine or a liquid crystal display device connected to a digital copying machine commonly used by a plurality of users.

However, it is difficult for such a conventional common advertisement apparatus to actually find sponsors for advertisements to be displayed or generate orders for advertised articles. In addition, the conventional common advertisement apparatuses have no means for making users directly place an order for a piece of advertised merchandise. In use of the conventional common advertisement apparatuses, therefore, a user must voluntarily look for a piece of advertised merchandise to purchase it.

For these reasons, the advertisement effect of the conventional common advertisement apparatuses is questionable, and many of them receive a few advertisement requests and hence offer, e.g., only image advertisements that cannot yield actual profits.

In Jpn. Pat. Appln. KOKAI Publication No. 10-204305, a function of allowing a user to directly place an order in an advertisement apparatus is provided only for a device such as a multimedia terminal having an advanced user interface. In this scheme, however, the user must voluntarily search for a piece of merchandise or place an order for a piece of merchandise when he/she takes a look at the displayed advertisement of the piece of merchandise. For this reason, if the user cannot decide to purchase the piece of merchandise when he/she is looking at the advertisement, an order is rarely made. Additionally, in such an advertisement apparatus shared by a plurality of users, a person who is placing an order occupies the advertisement apparatus during that process, so the actual advertisement time devoted to display on the display device is shortened.

### BRIEF SUMMARY OF THE INVENTION

The present invention has been made to solve the above problem that there is no means for making a user directly place an order for a piece of advertised merchandise, and to purchase the piece of advertised merchandise, the user must voluntarily look for the piece of merchandise, and has as its object to provide an advertisement system and method which facilitate purchase of advertised merchandise.

The present invention also has been made to solve the problem that the displayed advertisement of merchandise produces no actual profit because of a small number of users, and has as its another object to provide an advertisement system and method which can persuade a user to purchase merchandise and eliminate any labor and complex operation in purchasing merchandise.

It is still another object of the present invention to provide an advertisement system and method which allows a user to browse advertised merchandise any time under a familiar environment only by simple operation and prevent the advertisement apparatus from being occupied by a specific user and consequently decreasing the advertisement time.

It is still another object of the present invention to provide an advertisement system which can transmit an e-mail message with a purchase request for a piece of merchandise to a person who has a purchase right by simple operation when a user who wants to purchase the piece of merchandise is different from the person who has the purchase right.

It is still another object of the present invention to provide an advertisement system which can display only appropriate advertisements by limiting displayable advertisements in accordance with the installment situation and thus promote installment.

According to the present invention, there is provided an advertisement system which provides an advertisement of merchandise to a number of users, comprising a display device for displaying the advertisement of merchandise, a mail button for instructing to transmit, by an e-mail message, information related to the piece of merchandise of the advertisement displayed by the display device, an input device for inputting a recipient of the e-mail message for which transmission is instructed by the mail button, and a mail transmission device for, when the mail button is pressed, transmitting the e-mail message having the information of the piece of merchandise, including link information linked with a site on the Internet where the piece of merchandise is on sale, to the recipient input by the input device.

According to the present invention, there is also provided an advertisement system which provides an advertisement of merchandise to a number of users, comprising a display device for displaying the advertisement of merchandise, a memory for storing, as a bookmark, information related to the piece of merchandise displayed by the device, a registration button for registering the information related to the piece of merchandise as the bookmark when the advertisement of the piece of merchandise is being displayed on the device, and a server device for, upon being accessed from an external device, transmitting the information related to the piece of merchandise registered in the memory as the bookmark to the external device as data displayable on the external device, the data displayable on the external device containing link information linked with a site on the Internet where the piece of merchandise is on sale.

According to the present invention, there is also provided an advertisement system which provides an advertisement of merchandise to be sold on the Internet to a number of users, comprising a display device for displaying the advertisement of merchandise, a mail button for instructing to transmit, by an e-mail message, information related to the piece of merchandise of the advertisement displayed by the display device, an input device for inputting a recipient of the e-mail message for which transmission is instructed by the mail button, and a mail transmission device for, when the mail button is pressed, transmitting the e-mail message having the information of the piece of merchandise, including link information linked with a site on the Internet where the piece of merchandise is on sale, to the recipient designated by the input device, the link information containing information representing a presenter of the piece of merchandise, wherein when the piece of merchandise is purchased at the site on the Internet linked by the link information, a service corresponding to a payable amount for the piece of merchandise is provided to a buyer.

According to the present invention, there is also provided an advertisement system which provides an advertisement of merchandise provides an advertisement of merchandise to be sold on the Internet to a number of users, comprising a display device for displaying the advertisement of merchandise, a memory for storing, as a bookmark, information related to the piece of merchandise displayed by the device, a registration button for registering the information related to the piece of merchandise as the bookmark when the advertisement of the piece of merchandise is being displayed on the device, and a server device for, upon being accessed from an external device, transmitting the information related to the piece of merchandise registered in the memory as the bookmark to the external device as data displayable on the external device, the data displayable on the external device containing link information linked with a site on the Internet where the piece of merchandise is on sale, the link information containing information representing a presenter of the piece of merchandise, wherein when the piece of merchandise is purchased at the site on the Internet linked by the link information, a service corresponding to a payable amount for the piece of merchandise is provided to a buyer.

According to the present invention, there is also provided an advertisement method of providing an advertisement of merchandise to be sold on the Internet, comprising the first step of designating to transmit, by an e-mail message, information related to the piece of merchandise of the advertisement displayed on a display device usable by a number of users, the second step of designating a recipient of the e-mail message for which transmission is designated in the first step, the third step of, when transmission of the e-mail message is designated in the first step, transmitting the e-mail message having the information of the piece of merchandise, including link information linked with a site on the Internet where the piece of merchandise is on sale, to the recipient designated in the second step, the link information containing information representing a presenter of the piece of merchandise, and the fourth step of, when the piece of merchandise is purchased at the site on the Internet by the e-mail message transmitted in the third step, specifying the presenter by the link information and providing a service corresponding to a payable amount for the piece of merchandise to a buyer.

According to the present invention, there is provided an advertisement method of providing an advertisement of merchandise provides an advertisement of merchandise to be sold on the Internet, comprising the first step of storing, as a bookmark, information related to the piece of merchandise displayed on a device usable by a number of users in a memory, the second step of, in accordance with an access from an external device, transmitting the information related to the piece of merchandise registered in the memory as the bookmark in the first step to the external device as data displayable on the external device, the data displayable on the external device containing link information linked with a site on the Internet where the piece of merchandise is on sale, and the link information containing information representing a presenter of the piece of merchandise, and the third step of, when the piece of merchandise is purchased at the site on the Internet linked by the link information of the bookmark displayed on the external device by the data transmitted in the second step, providing a service corresponding to a payable amount for the piece of merchandise to a buyer.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view schematically showing the overall arrangement of an advertisement system;

FIG. 2 is a view showing the schematic arrangement of a common advertisement apparatus;

FIG. 3 is a view showing the arrangement of an advertisement master table;

FIG. 4 is a view showing the arrangement of a presentation site table;

FIG. 5 is a view showing the arrangement of an advertisement category master table;

FIG. 6 is a view showing the arrangement of a permission category table;

FIG. 7 is a view showing the arrangement of an advertisement log (bookmark) table;

FIG. 8 is a view showing the arrangement of an address log table;

FIG. 9 is a view showing the arrangement of a user master table;

FIG. 10 is a view showing the arrangement of a permission category table;

FIG. 11 is a view showing the arrangement of an advertisement log table;

FIG. 12 is a view showing the arrangement of a bookmark table;

FIG. 13 is a view showing the arrangement of a form table;

FIG. 14 is a view showing the structure of a form character string;

FIG. 15 is a view showing the structure of another form character string;

FIG. 16 is a view showing a display example of an advertisement window;

FIG. 17 is a view showing a display example of a radio device selection window;

FIG. 18 is a view showing a display example of an address selection window;

FIG. 19 is a view showing a display example of a log selection window;

FIG. 20 is a view showing a display example of an address input window;

FIG. 21 is a view showing a display example of a form selection window;

FIG. 22 is a flow chart for explaining operation when a mail button is pressed;

FIG. 23 is a flow chart for explaining the operation when the mail button is pressed;

FIG. 24 is a flow chart for explaining operation when a bookmark button is pressed;

FIG. 25 is a view showing a display example of a web page displayed by referring to the bookmark;

FIG. 26 is a flow chart for explaining the creation algorithm for the web page displayed by referring to the bookmark;

FIG. 27 is a flow chart for explaining operation of registering the bookmark for each user;

FIG. 28 is a view showing a display example of a user selection window in registering the bookmark for each user;

FIG. 29 is a flow chart for explaining an algorithm for managing the advertisement log;

FIG. 30 is a flow chart for explaining user-side operation in purchasing a piece of merchandise presented by the common advertisement apparatus;

FIG. 31 is a flow chart for explaining operation on the side of a site that sells merchandise presented by the common advertisement apparatus; and

FIG. 32 is a flow chart for explaining operation on the advertisement server side in purchasing merchandise presented by the common advertisement apparatus.

### DETAILED DESCRIPTION OF THE INVENTION

An embodiment of the present invention will be described below in detail with reference to the accompanying drawing.

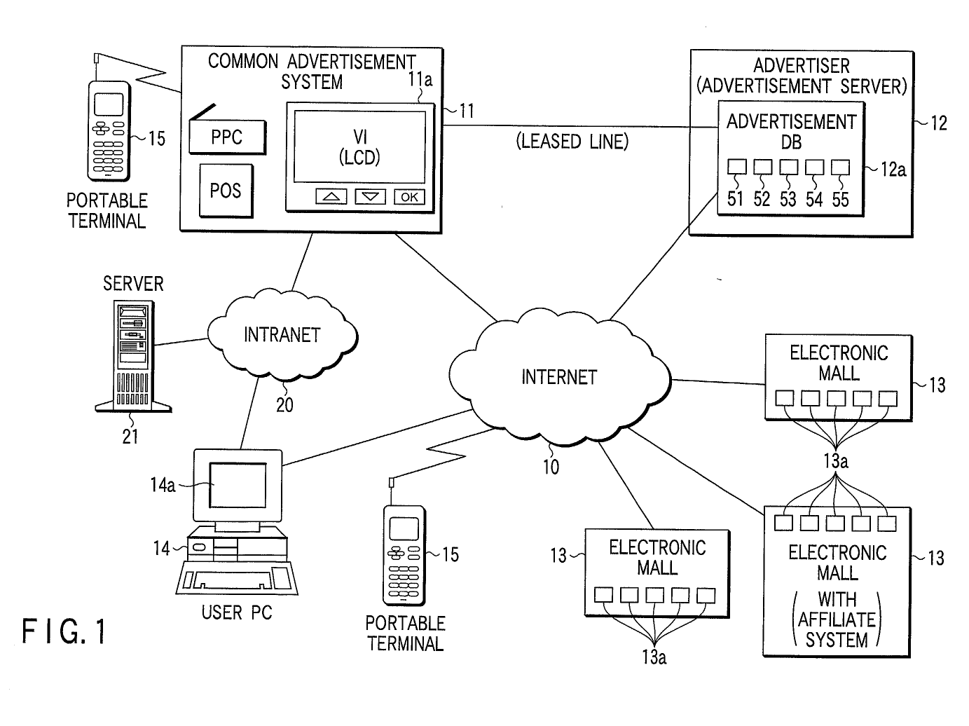

FIG. 1 is a view schematically showing the overall arrangement of an advertisement system according to the present invention.

As shown in FIG. 1, this advertisement system is constituted by the Internet 10, common advertisement apparatus 11, advertisement DB 12, electronic malls 13, user PC 14, portable terminal 15, intranet 20, and server 21.

The common advertisement apparatus 11 is connected to the advertisement DB 12, electronic malls 13, user PC 14, and portable terminal 15 through the Internet 10. The advertisement DB 12 and common advertisement apparatus 11 may be connected by a leased line 30. The common advertisement apparatus 11 is also connected to the server 21 and user PC 14 through the intranet 20. That is, the common advertisement apparatus 11 is connected to the constituent elements through the Internet 10, intranet 20, or leased line 30.

The common advertisement apparatus 11 has a display device (LCD) 11a serving as a user interface used by a plurality of users. The LCD 11a is formed from, e.g., a liquid crystal display device that incorporates a touch panel (input device). A common digital copying machine (PPC), automatic vending machine, or a terminal (cash register) of a POS system is assumed as a common advertisement apparatus having such an LCD 11a. That is, a digital copying machine (PPC), automatic vending machine, or a terminal (cash register) of a POS system, which has a customer display device and can be used by many unspecified users, is used as a common advertisement apparatus.

Each of the electronic malls 13 represents a virtual shopping mall on the Internet, which is built by the WWW (World Wide Web) (also to be simply referred to as a web hereinafter). A plurality of electronic stores (sites) 13a that sell merchandise such as articles or services are opened in the electronic malls 13. A user who accesses each electronic mall 13 through the Internet 10 can purchase merchandise handled by the electronic stores 13a in the electronic mall 13. Some electronic malls 13 employ a system called an affiliate system as in U.S. Pat. No. 6,029,141. The affiliate system pays a presentation charge when a piece of merchandise is actually sold by presentation.

The user PC 14 is a personal computer for user's personal use. With the user PC 14, each user executes transmission/reception of electronic mail (e-mail) and Internet connection. In use in a school or office, the user PC 14 may be connected to the intranet 20. The server 15 functions as a server computer of the intranet 20 when the user PC 14 is connected to the intranet 20.

The portable terminal 15 is a portable telephone or a portable mail terminal and has a function of connecting to the Internet 10 or a function of allowing local radio communication.

The common advertisement apparatus 11 will be described next.

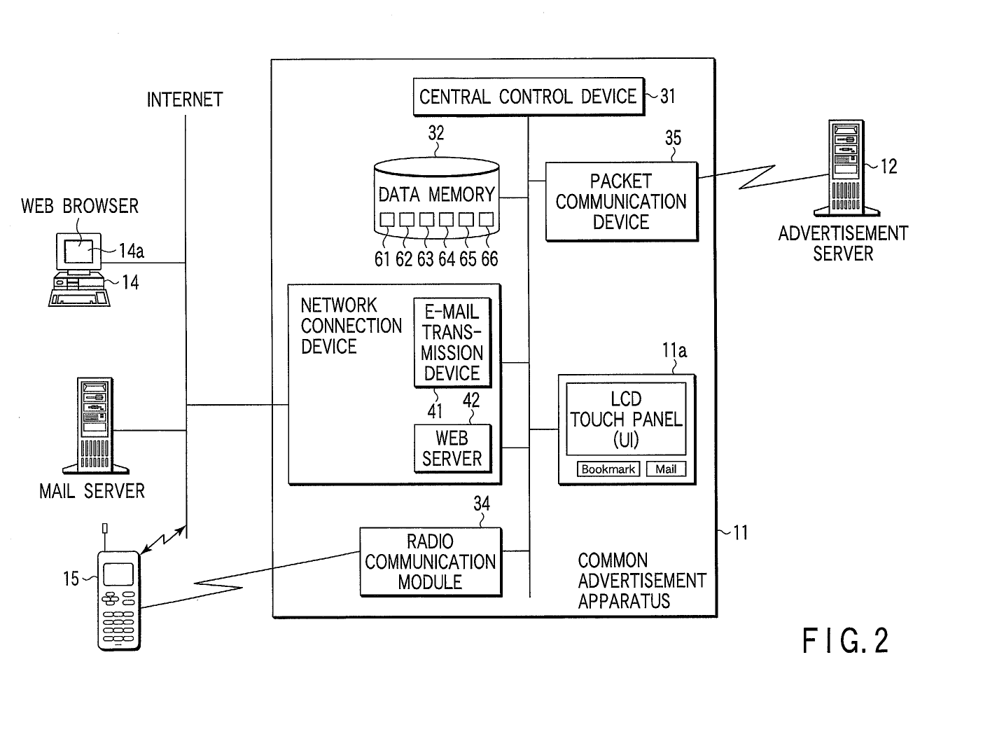

FIG. 2 is a view showing the schematic arrangement of the common advertisement apparatus 11. As shown in FIG. 2, the common advertisement apparatus 11 has the user interface 11a, central control device 31, data memory 32, network connection device 33, radio communication module 34, and packet communication device 35.

The central control device 31 controls the entire common advertisement apparatus. The data memory 32 stores various data. The network connection device 33 executes connection to a network. This network connection device 33 has an e-mail transmission device (mail transmission device) 41 and web server (server device) 42. The e-mail transmission device 41 transmits an e-mail message to the user PC 14 or the like through the Internet. With the web server 42, the common advertisement apparatus 11 provides pages onto the Internet 10.

The radio communication module 34 performs radio communication with the portable terminal 15. The radio communication module 34 performs radio communication corresponding to the communication scheme of the portable terminal 15.

The packet communication device 35 function as a communication means with the server 12 of an advertiser. Packet communication that is used by a portable telephone or the like is employed here. Communication between the server 12 of the advertiser and the common advertisement apparatus 11 may be done not only by the packet communication used by a portable telephone but also by communication using a PHS, public line connection by a FAX modem, or Internet connection such as VPN through the intranet 20.

In the advertisement system including the common advertisement apparatus having the above arrangement, a preset presentation charge is paid to a presenter. In such an advertisement system, the URL (Uniform Resource Locator) of a piece of merchandise or the URL of a category is issued in units of presenters, so that the presenter (sponsor) is specified in selling the piece of merchandise. That is, in this advertisement system, to authenticate the presenter of a piece of merchandise, a piece of merchandise must be purchased through a URL that can specify the presenter.

Additionally, in this advertisement system, when a piece of merchandise is purchased through a URL that can specify the presenter, the presentation charge paid from the merchandise seller to the presenter is partially repaid to the merchandise buyer. Hence, when a piece of merchandise is purchased using this advertisement system, the buyer can enjoy discount or cash back. Setting such an advantage for buyers wakes motivation for merchandise purchase in this advertisement system.

Some methods can be used to refund the discount or cash back amount to the buyer. In this case, the URL for specifying the presenter is acquired not for each advertiser but for each common advertisement apparatus, and different URLs are presented in units of common advertisement apparatuses operated by the user. with this arrangement, a presentation charge totalized for each common advertisement apparatus can be obtained from the piece of merchandise seller, and a proportion of the presentation charge can be repaid to the piece of merchandise buyer.

An advertisement DB 12a prepared in the server 12 by an advertiser will be described next.

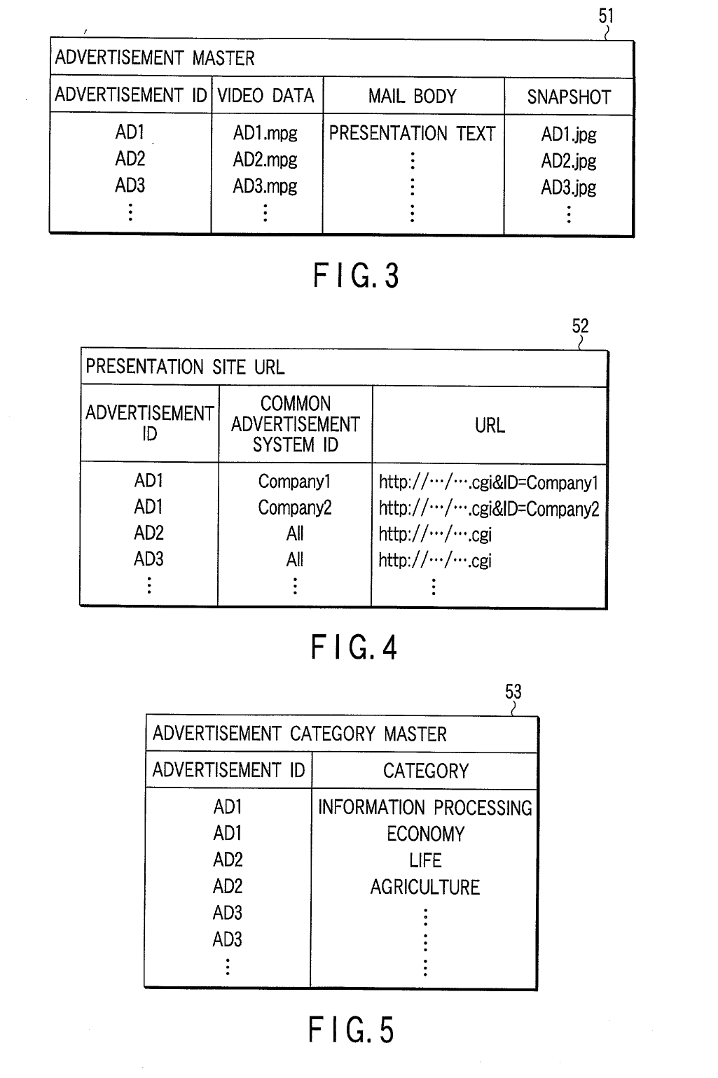

FIGS. 3 to 7 are views showing the arrangements of various tables provided in the advertisement DB 12a. As shown in FIGS. 3 to 7, the advertisement DB 12a has tables such as an advertisement master table 51, presentation site table 52, advertisement category master table 53, permission category table 54, and advertisement log (bookmark) table 55.

As shown in FIG. 3, the advertisement master table 51 has an item where the advertisement IDs of advertisements are stored, and items “video data (VideoData)”, “presentation text (MailBody)”, and “snapshot” are prepared for each advertisement ID.

Video data (file names of video data) displayed on the common advertisement apparatus as advertisements are stored at the item “video data”. Presentation texts used to guide the user to presentation sites by e-mail or the like are stored at the item “presentation text”. Image data (file names of image data), that extract impressive frames of video data to make the user easily remember the advertisements later, are stored at the item “snapshot”. The snapshot need not always be image data extracted from video data.

The presentation site table 52 assigns an advertisement system ID to each common advertisement apparatus and manages URLs in units of IDs. As shown in FIG. 4, the presentation site table 52 has items “advertisement ID”, “advertisement system ID”, and “URL (Uniform Resource Locator)”.

Advertisement IDs corresponding to advertisements are stored at the item “advertisement ID”. System IDs assigned to the respective common advertisement apparatuses are stored at the item “advertisement system”. URLs corresponding to the advertisement IDs and system IDs are stored at the item “URL”. Each URL contains information capable of specifying a common advertisement apparatus as an advertisement presenter. If the operator that operates the advertisement server 12 as an advertiser is the same as the operator that operates the common advertisement apparatus, the URL may be set such that the advertisement server 12 becomes the advertisement presenter.

The advertisement category master table 53 manages categories to which advertisements belong in units of advertisements. As shown in FIG. 5, the advertisement category master table 53 has items “advertisement ID” and “category”.

Advertisement IDs corresponding to advertisements are stored at the item “advertisement ID”. Pieces of category information for advertisements corresponding to the advertisement IDS are stored at the item “category”.

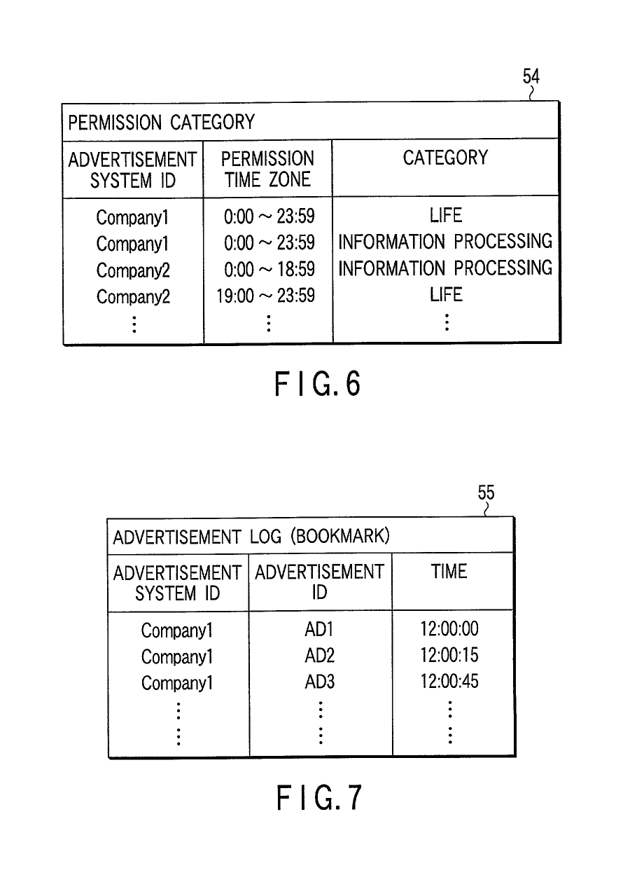

The permission category table 54 holds, for each of the system IDS of the common advertisement apparatuses, the categories of advertisement for which display is permitted, and time zones when display of a piece of merchandise advertisements belonging to these categories is permitted. As shown in FIG. 6, the permission category table 54 has items “advertisement system ID”, “permission time zone”, and “category”. In each common advertisement apparatus, the categories of a piece of merchandise whose advertisements can be displayed and the time zones when the advertisements can be displayed are limited on the basis of the recorded contents of the permission category table 54.

System IDs assigned to the respective common advertisement apparatuses are stored at the item “advertisement system”. Pieces of category information for advertisements corresponding to the advertisement IDS are stored at the item “category”. Time zones when display of the advertisements of merchandize belonging to the categories stored at the item “category” is permitted on the common advertisement apparatuses represented by the advertisement system IDs are stored at the item “permission time zone”. Time zones when display is permitted may be stored at the item “permission time zone” in units of pieces of merchandize. The permission category table may be stored in the data memory in the common advertisement apparatus 11, as will be described later. In this case, advertisement system IDS need not be stored in the permission category table.

The advertisement log (bookmark) table 55 manages the advertisement log or bookmark. As shown in FIG. 7, the advertisement log (bookmark) table 55 has items “advertisement system ID”, “advertisement ID”, and “time”.

Pieces of ID information assigned to the respective advertisement systems are stored at the item “advertisement system”. Pieces of ID information corresponding to advertisements are stored at the item “advertisement ID”. Times when the advertisements represented by the advertisement IDs were displayed on the common systems represented by the system IDs or times when the advertisements were bookmarked are stored at the item “time”. The common advertisement table 55 may be stored in the data memory 32 in the common advertisement apparatus 11, as will be described later.

Various tables prepared in the data memory 32 in the common advertisement apparatus 11 will be described next.

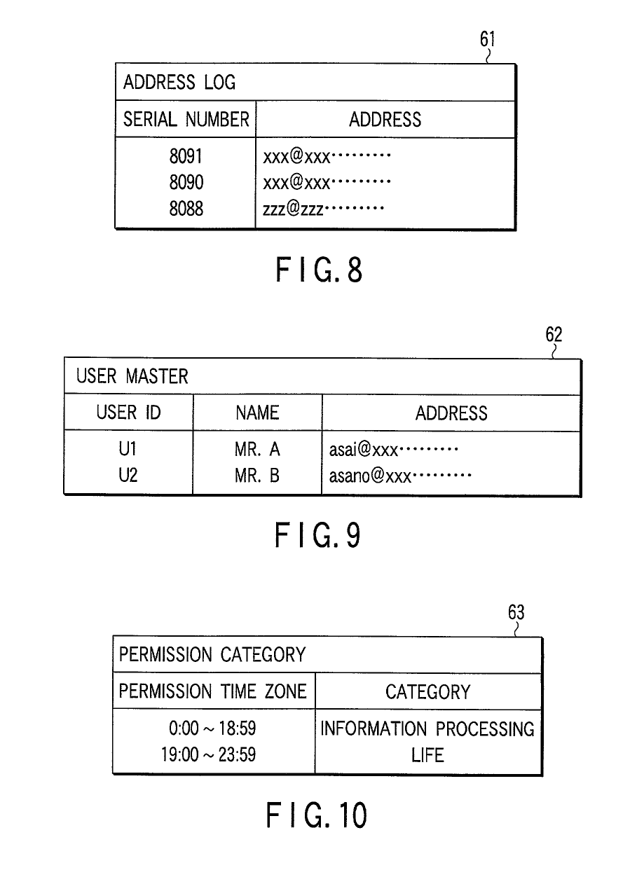

FIGS. 8 to 15 are views showing the arrangements of various tables prepared in the data memory 32. The data memory 32 has an address log table 61, user master table 62, permission category table 63, advertisement log table 64, bookmark table 65, and form table 66.

The address log table 61 manages the log of addresses for transmitted mail messages. The address log table 61 has items “serial number” and “address”. Numbers that are sequentially assigned to mail messages transmitted from the common advertisement apparatus are stored at the item “serial number”. The addresses for the transmitted mail messages are stored at the item “address”.

Hence, in the address log table 61, when a mail message is transmitted, a serial number is issued, and an address is stored in correspondence with this serial number. Thus, the address log table 61 stores a transmitted mail log in which the serial numbers are arranged sequentially from the latest number.

The user master table 62 manages detailed user information for each user. The user master table 62 has items “user ID”, “name”, and “address”. IDs assigned to the respective users are stored at the item “user ID”. User names are stored at the item “name”. Mail addresses as addresses for mail messages to the users are stored at the item “address”.

The permission category table 63 has items “permission time zone” and “category”, as in the permission category table 54. The arrangement of the permission category table 63 shown in FIG. 10 is applied particularly when the common advertisement apparatus 11 has the permission category table. Pieces of category information corresponding to the advertisement IDs are stored at the item “category”. Time zones when display of the advertisements belonging to the categories stored at the item “category” is permitted on the advertisement system represented by the advertisement system ID are stored at the item “permission time zone”.

The advertisement log table 64 manages the advertisement log, like the advertisement log table 55. The arrangement of the advertisement log table 64 shown in FIG. 11 is applied particularly when the common advertisement apparatus has the table. AS shown in FIG. 11, the advertisement log table 64 has items “advertisement system ID”, “advertisement ID”, and “time”. Pieces of ID information for advertisements are stored at the item “advertisement ID”. Times when the advertisements represented by the advertisement IDS were displayed are stored at the item “time”.

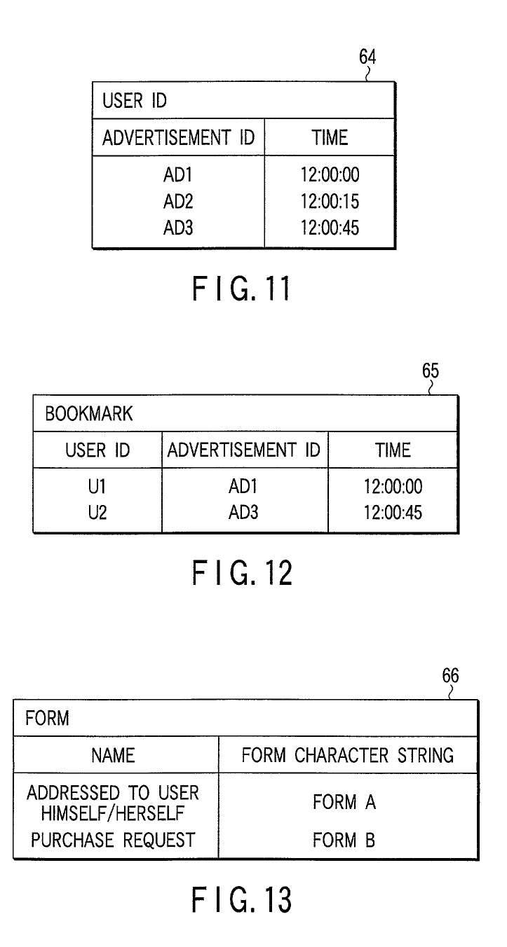

The bookmark table 65 manages the bookmark, like the bookmark table 55. The arrangement of the bookmark table 65 shown in FIG. 12 is applied particularly when the common advertisement apparatus 11 has the table. In this case, user IDs are additionally managed such that different bookmarks can be managed in units of users.

The bookmark table 65 shown in FIG. 12 has items “user ID”, “advertisement ID”, and “time”. IDS assigned to the respective users are stored at the item “user”. Pieces of ID information corresponding to advertisements are stored at the item “advertisement ID”. Times when the advertisements represented by the advertisement IDs were displayed are stored at the item “time”. The bookmark for each user may be stored in the advertisement DB 12.

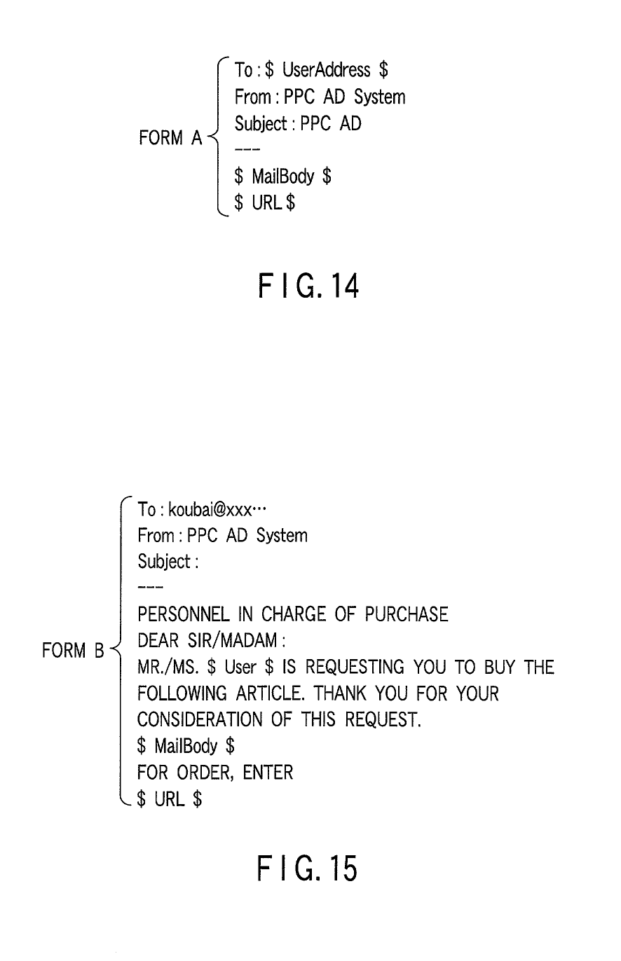

The form table 66 manages forms by naming them. As shown in FIG. 13, the form table 66 has items “name” and “form character string”. Names (titles) of mail messages to be transmitted are stored at the item “name”. Mail contents corresponding to the names are stored at items “form character string” as character strings. FIGS. 14 and 15 are views showing examples of form character strings with names “addressed to user himself/herself” and “purchase request”.

FIG. 14 shows the contents of a mail message named “addressed to user himself/herself”. The example shown in FIG. 14 indicates a mail form when a mail message related to a piece of merchandise advertised by the common advertisement apparatus is to be transmitted to the user himself/herself. In the form of a mail message addressed to the user himself/herself, the address is a variable “UserAddress”, the sender is the name (“PPC AD system”) of the common advertisement apparatus, the mail text is a variable “MailBody”, and also a variable “URL” linked with the piece of merchandise seller is set.

FIG. 15 shows the contents of a mail message named “purchase request”. The example shown in FIG. 15 indicates a mail form when the user who browses a piece of merchandise advertised by the common advertisement apparatus is different from the buyer (person in charge of purchase) who actually purchases the piece of merchandise, and a mail message related to the piece of merchandise is to be transmitted to the buyer. In the form of a mail message addressed to the buyer shown in FIG. 15, the address is a mail address such as “koubai@××× . . . ” to the buyer, the sender is the name (PPC AD system) of the common advertisement apparatus, the mail text is formed from an advice with a definite pattern for the person in charge of purchase and a variable “MailBody”, and also a variable “URL” linked with the piece of merchandise seller is set.

Display windows displayed on the LCD 11a of the common advertisement apparatus 11 in transmitting a mail message related to a piece of merchandise will be described next. FIG. 16 is a view showing a display example of an advertisement window 71 which displays an advertisement of merchandise on the LCD 11a. As shown in FIG. 16, the advertisement of merchandise is displayed in the advertisement window 71. A mail button 71a and bookmark button 71b are also displayed on the LCD 11a.

The mail button 71a is pressed when the user purchases the piece of merchandise of the displayed advertisement or feels an interest in the piece of merchandise of the advertisement. When the mail button 71a is pressed, an e-mail message formed from information related to the piece of merchandise is transmitted to an address designated by the user. The e-mail message contains not only detailed information related to the piece of merchandise but also a URL easy to link with a site (web page) where an order can be placed. When the bookmark button 71b is pressed, setting is done to allow the user to easily link with the advertisement page.

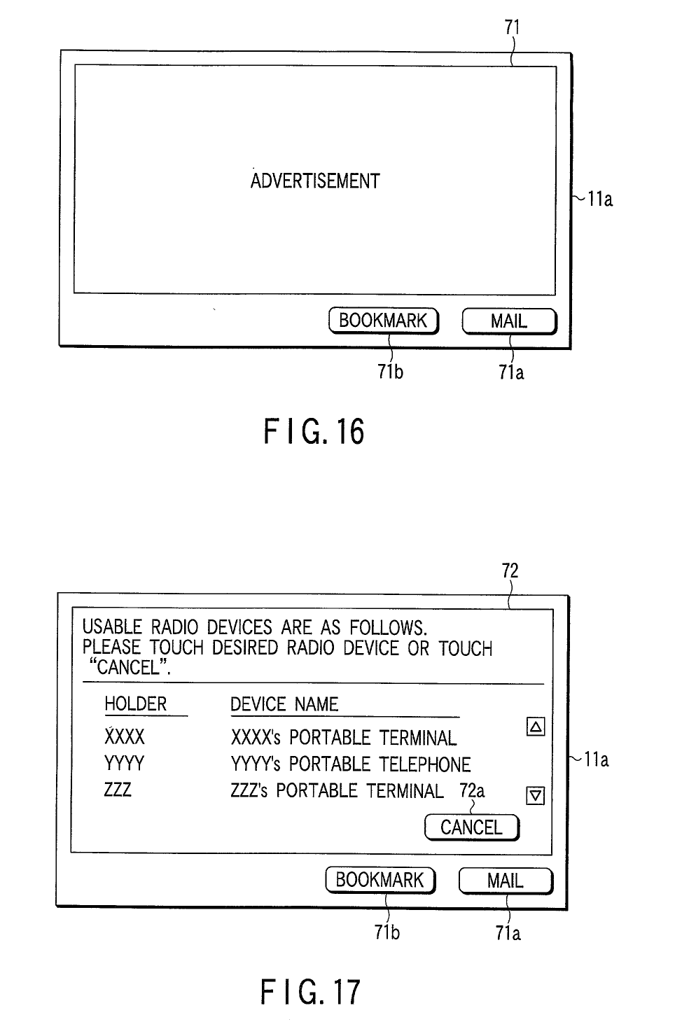

FIGS. 17 to 21 are views showing display examples of windows displayed on the LCD 11a in transmitting mail related to merchandise.

FIG. 17 is a view showing a display example of a radio device selection window 72 in transmitting a mail message to the radio device 15. In transmitting a mail message related to a piece of merchandise from the common advertisement apparatus 11, a portable radio device (portable terminal) held by the user can be selected as a mail recipient. That is, the common advertisement apparatus 11 can communicate with the radio device using the radio device module 34. When the user designates the radio device held by the user as a mail recipient, the common advertisement apparatus 11 transmits a mail message to the radio device using the radio device module 34.

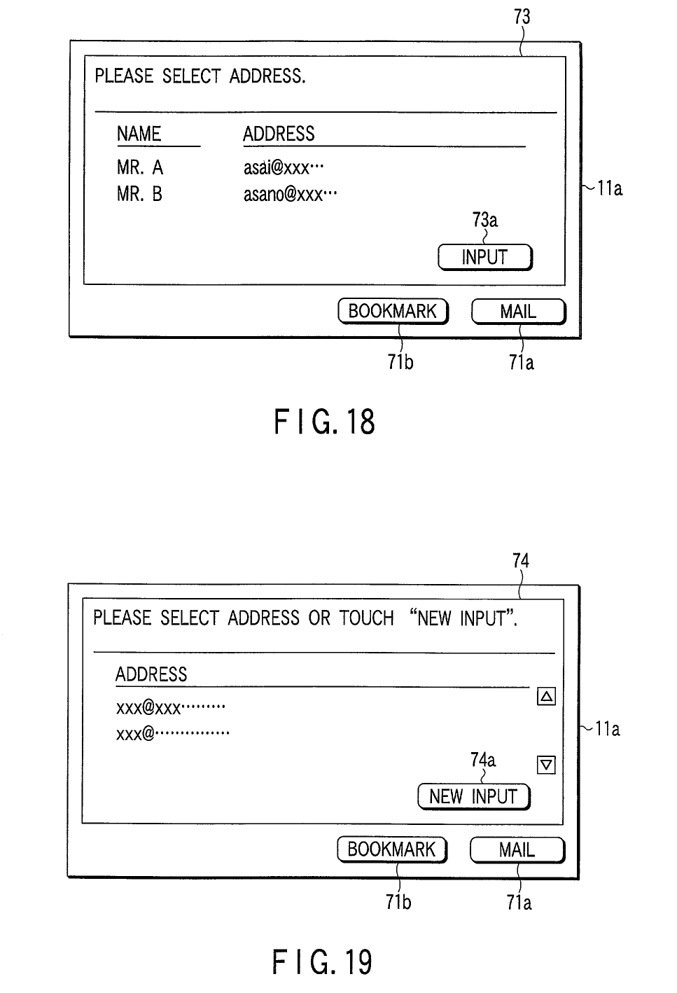

As shown in FIG. 17, an operation guide, list of usable radio devices, and cancel button 72a are displayed in the radio device selection window 72. As the operation guide, for example, a radio device selection guide, “Radio devices below are usable. Please touch a desired device for transmission or touch “cancel”” is displayed. As the list of usable radio devices, the names of holders and device names of usable radio devices are displayed. The cancel button 72a is pressed not to set any displayed radio device as a mail recipient. When the cancel button 72a is pressed, an address selection window shown in FIG. 18 is displayed on the LCD 11a.

FIG. 18 is a view showing a display example of an address selection window 73 displayed on the LCD 11a in selecting an address from user information registered in the user master table 62. An operation guide, address information, and input button 73a are displayed in the address selection window 73. As the operation guide, for example, an address selection guide, “Please select an address” is displayed. As the address information, a list of address information containing user names and addresses is displayed. These pieces of address information are displayed on the basis of the contents of the user master table 62. The input button 73a is pressed when the displayed list of address information has no desired address. When the input button 73a is pressed, a log selection window as shown in FIG. 19 is displayed on the LCD 11a.

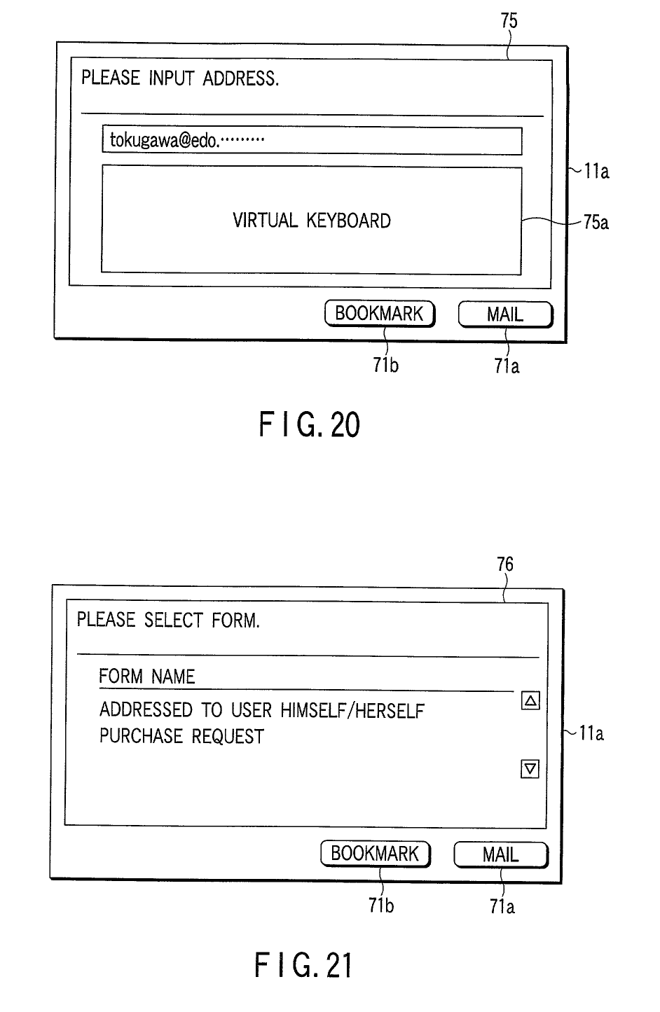

FIG. 19 is a view showing a display example of a log selection window 74 displayed on the LCD 11a in selecting an address from the transmission log stored in the log table 61. An operation guide, address information, and new input button 74a are displayed in the log selection window 74. As the operation guide, for example, an address selection guide, “Please select an address or touch “new input”” is displayed. As the address information, a list of addresses as a transmission log is displayed. These pieces of address information are displayed on the basis of the contents of the transmission log table 61. The new input button 74a is pressed when the displayed transmission log list has no desired address, and an address need to be newly input. When the new input button 74a is pressed, an address input window as shown in FIG. 20 is displayed on the LCD 11a.

FIG. 20 is a view showing a display example of an address input window 75 displayed on the LCD 11a in newly inputting an address. An operation guide, virtual keyboard 75a, and address display column are displayed in the address input window 75. As the operation guide, for example, an address input guide, “Please input an address” is displayed. As the virtual keyboard 75a, a keyboard which allows input by a touch panel is displayed. The user inputs characters or symbols of an address by touching keys on the virtual keyboard 75a. The characters and symbols input with the virtual keyboard 75a are displayed in the address display column. In this embodiment, the address is input using the touch panel provided on the LCD 11a. However, the address may be input using a keyboard formed from hard keys.

FIG. 21 is a view showing a display example of a form selection window 76 displayed on the LCD 11a in selecting the form of a mail message to be transmitted. In the common advertisement apparatus 11, a mail form can be designated in accordance with the mail recipient or contents of a piece of merchandise in transmitting a mail message related to the piece of merchandise. The mail form can be selected from forms registered in the form table 66. For example, when the form of a mail message addressed to the user himself/herself and the form of a mail message addressed to the person in charge of purchase are registered in the form table 66, as shown in FIGS. 14 and 15, the user can select one of the forms in accordance with the intended recipient of a mail message related to a piece of merchandise advertised by the common advertisement apparatus 11.

As shown in FIG. 21, an operation guide and form list are displayed in the form selection window 76. As the operation guide, for example, a form selection operation guide, “Please select a form” is displayed. As the form list, a list of names of forms that can be selected is displayed. As the selectable forms, forms registered in the form table 66 are displayed.

Operation when the mail button 71a is pressed will be described next.

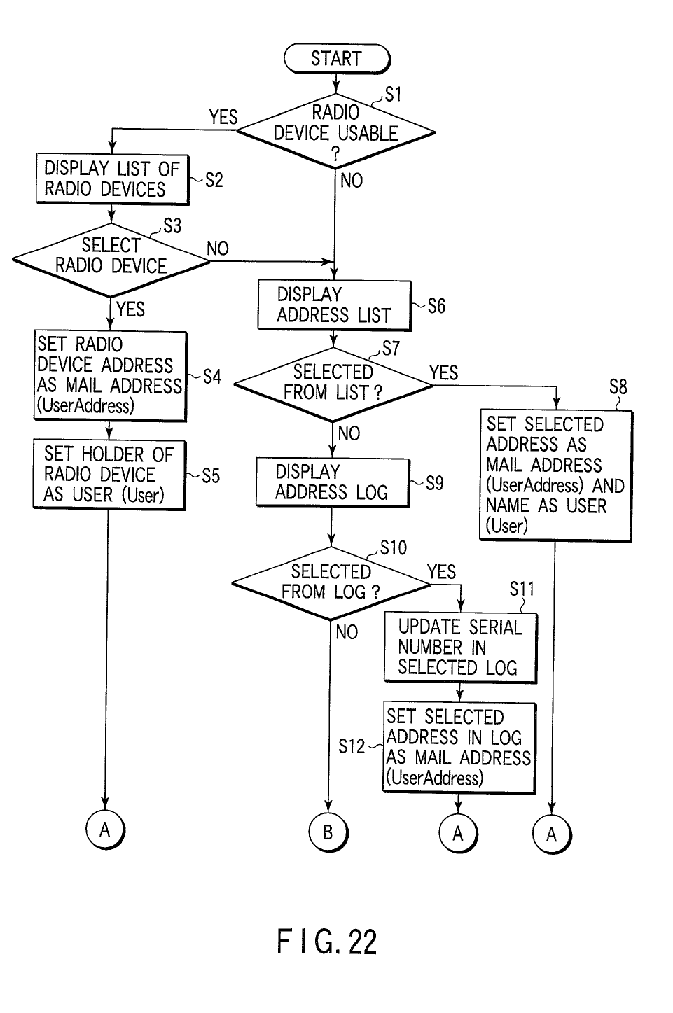

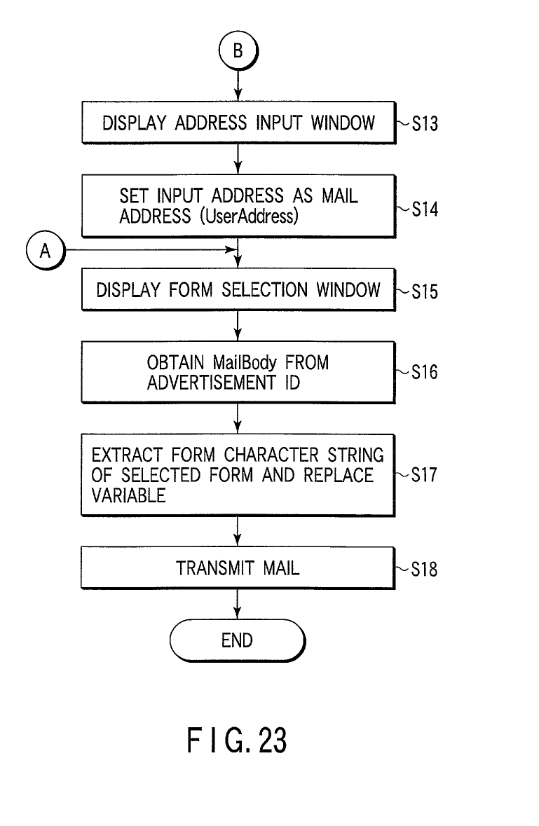

FIGS. 22 and 23 are flow charts for explaining operation after the mail button 71a is pressed. A case wherein in the advertisement window shown in FIG. 16, the user feels an interest in the advertisement and presses the mail button 71a will be described here.

When the mail button 71a is pressed, the central control section 31 of the common advertisement apparatus 11 transmits an inquiry signal from the radio communication module 34, thereby inquiring whether a usable radio device is present in the effective range. When a response to the inquiry signal is detected, the central control section 31 determines that a radio device can be used. When no response is detected, the central control section 31 determines that no radio device can be used (YES in step S1).

When it is determined by this determination that usable radio devices are present, the central control device 31 displays a list of all usable radio devices on the LCD 11a, as shown in FIG. 17 (step S2).

The user selects a radio device to which the advertisement is to be transferred from the radio devices displayed on the LCD 11a. If no radio device to which the advertisement need be transferred is present, the user selects “cancel”.

When a radio device is selected as an advertisement transfer destination (YES in step S3), the central control device 31 sets the mail address of the selected radio device (or the address of a local short message) as a mail address (variable UserAddress) (step S4). The central control device 31 also sets the holder of the selected radio device as a user name (variable User) (step S5). The user name to be set need not always be the holder of the radio device but may be the name of the device.

When no usable radio device is present (NO in step S1), or no radio device is selected (NO in step S3), the central control device 31 displays an address list on the LCD 11a, as shown in FIG. 18 (step S6). As the address list displayed on the LCD 11a, the list of addresses registered in the user master table 62 is displayed. The user selects an address from the address list displayed on the LCD 11a. If no desired address is present in the list displayed on the LCD 11a, the user presses the input button 73a.

When an address is selected from the list, the central control device 31 sets the selected address as a mail address (UserAddress) and also sets the name of the selected address as a user name (User) (step S8).

When the input button 73a is pressed, the central control device 31 displays the list of addresses as an address log on the LCD 11a (step S9). As the addresses displayed on the LCD 11a, addresses stored in the address log table 61 are displayed as a list. The user selects an address from the log list displayed on the LCD 11a. If no desired address is present in the log address displayed on the LCD 11a, the user presses the new input button.

When an address is selected from the log displayed on the LCD 11a, the central control device 31 sets the serial number of the selected log to a value obtained by adding 1 to the maximum value of serial numbers in the address log table 61 (step S11). The central control device 31 sets the address of the selected log as a mail address (UserAddress) (step S12).

When the new input button is pressed, the central control device 31 displays the address input window for inputting an address, as shown in FIG. 20 (step S13). A keyboard which allows input by a touch panel is displayed in the address input window. The user inputs a mail address as an address using the keyboard displayed in the address input window. When the user inputs an address in the address input window, the central control device 31 sets the input address as a mail address (UserAddress).

When the mail address is set in step S4, S8, S12, or S14, the central control device 31 displays the form selection window for selecting a form as mail contents, as shown in FIG. 13 (step S15). In this form selection window, a form is selected from form names stored in the form table 66.

When the user selects a form in the form selection window, the central control device 31 searches the advertisement master table 51 on the basis of the advertisement ID of the advertisement selected by the user (advertisement that be being displayed when “mail transmission” is pressed). By this search, the central control device 31 reads out a MailBody corresponding to the advertisement ID.

The central control device 31 reads out a form character string corresponding to the form name selected from the form table 66. The central control device 31 replaces variable portions (UserAddress, User, and MailBody) in the readout form character string with the set character string. Thus, mail to be transmitted is completed.

When the mail message to be sent is complete, the central control device 31 transmits the mail message. When the address of the mail message is a radio device, and the radio device receives local communication, the central control device 31 transmits the mail message through the radio device module. Otherwise, the mail message is transmitted using the e-mail transmission device.

As described above, for example, an advertisement of a piece of merchandise for sale on an Internet site is presented, a mail button for instructing to transmit a presentation mail message for the piece of merchandise is prepared, and when the mail button is pressed, an e-mail message of a piece of merchandise information containing link information that can be linked with a site (web page) where the piece of merchandise is on sale is transmitted for the user to a recipient designated by the user.

With this arrangement, the user need not directly place an order for the piece of merchandise on the common advertisement apparatus. For this reason, the time when the apparatus is occupied by a specific user becomes short, and the advertisement effect is expected to improve. In addition, the user need not immediately place an order for a piece of merchandise of his/her interest and can examine purchase of the piece of merchandise at home or the like in consideration of the piece of merchandise information. Consequently, sales of merchandise presented by the common advertisement apparatus can be improved.

Operation when the bookmark button 71b is pressed will be described next.

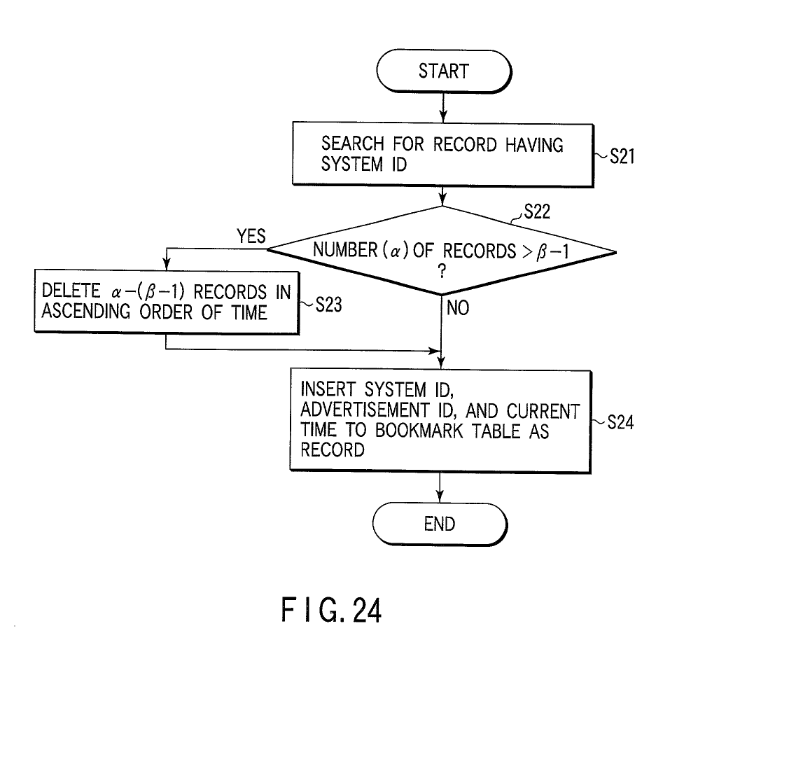

FIG. 24 is a flow chart for explaining operation after the bookmark button is selected. A case wherein an advertisement is registered as a bookmark for each common advertisement apparatus, as in the advertisement log (bookmark) table 55, will be described here.

Assume that the user presses the bookmark button 71b in the advertisement window 71 as shown in FIG. 16. The central control device 31 of the common advertisement apparatus 11 connects to the advertisement server and searches the advertisement log (bookmark) table 55 in the advertisement DB 12a for records having the system ID of the common advertisement apparatus (step S21). On the basis of the search result, the central control device 31 discriminates the number (α) of records with the system ID of the common advertisement apparatus 11.

In the bookmark table 55 of the advertisement DB 12a, the number of records that can be registered as bookmarks is preset for each system ID. This number is represented by β. In this case, the central control device 31 compares α with β−1 on the basis of the number a of records and the number β of records that can be left as bookmarks (step S22). If it is determined that the number α of records is larger than β−1 (α>β−1) (YES in step S22), the central control device 31 deletes α−(β−1) records from the records with the system ID of the common advertisement apparatus in the ascending order of time (step S23).

When the α−(β−1) records are deleted in the ascending order of time, or it is determined that the number α of records is smaller than β−1 (α<β−1) (NO in step S22), the central control device 31 registers a new record in the bookmark table 55. The system ID, the advertisement ID of the advertisement which is being displayed when the bookmark button is pressed, and the current time are stored in the newly registered record.

A case wherein the user browses an advertisement registered as a bookmark will be described next.

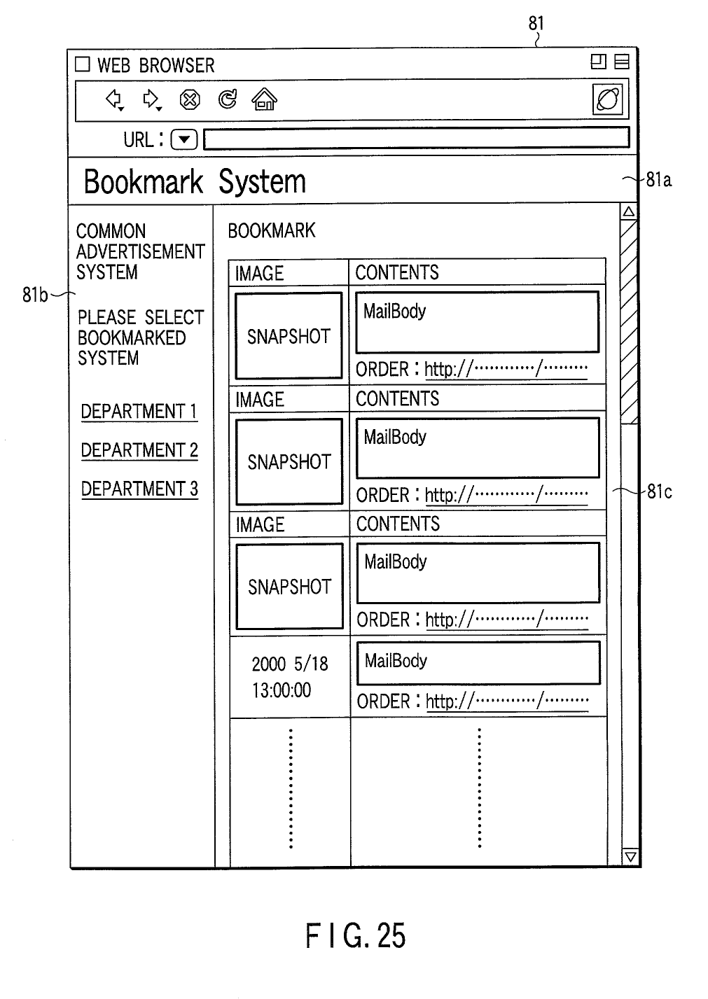

FIG. 25 is a view showing a display example when an advertisement is displayed in the user PC 14 by referring to the bookmark. A display window 81 is displayed on a display 14a of the user PC 14 when the user connects the user PC 14 to a bookmarked common advertisement apparatus. Such a display window is displayed by, e.g., executing an application program installed in the user PC 14 in advance.

As shown in FIG. 25, the display window 81 has three frames 81a, 81b, and 81c. In this display window 81, a title is displayed in the upper frame 81a, a list of bookmarked common advertisement apparatuses is displayed in the left frame 81b, and a list of bookmarks is displayed in the right frame 81c.

The user activates an application and selects a common advertisement apparatus where the user bookmarked the advertisement. At this time, the user may be required to input a password to authenticate whether the user is an authentic person. When the user selects a bookmarked common advertisement apparatus, the user PC 14 is connected to the web server 42 of the selected common advertisement apparatus 11 through the Internet 10. The web server 42 transmits the contents of all bookmarks corresponding to the user ID in accordance with the access from the user PC 14. The user PC 14 displays on the display 14a the contents bookmarked in the common advertisement apparatus in the right frame (bookmark frame) 81c. The frame 81c has first and second columns.

In the frame 81c shown in FIG. 25, first several pieces of merchandise are displayed as images in the first column to allow the user to perform intuitive operation. Except for these merchandise, not images but bookmark times are displayed in the first column to reduce the data transfer amount or decrease the number of lines necessary for one entry. In the frame 81c shown in FIG. 25, presentation texts of the piece of merchandise and URLs for an order for the piece of merchandise are displayed in the second column. Using such a bookmark list, the user who decides the purchase of a piece of merchandise only need click on the URL to link with the web page where the piece of merchandise can be purchased.

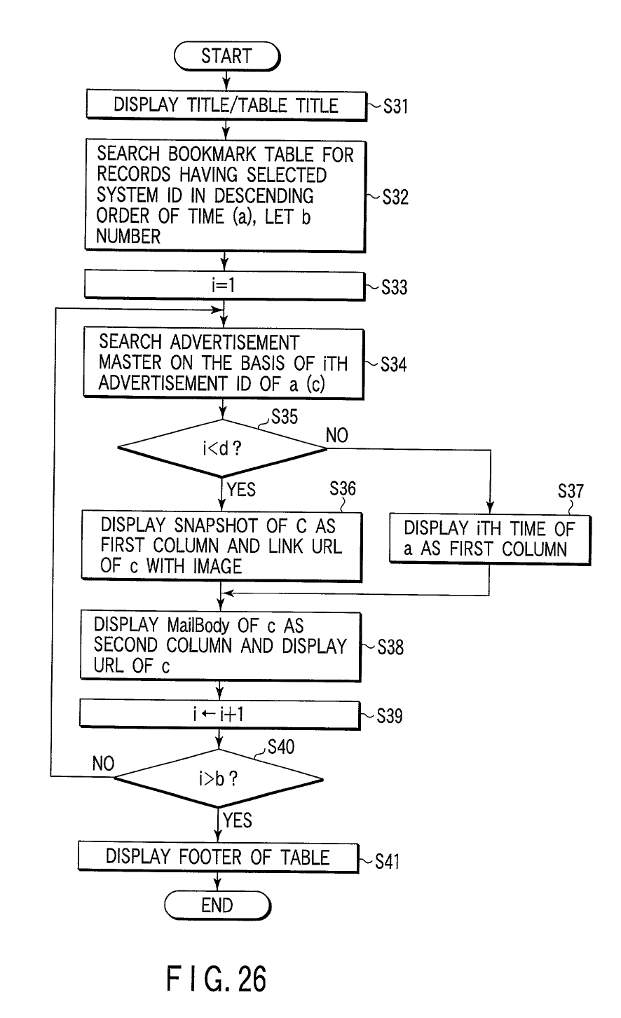

FIG. 26 is a flow chart for explaining the creation algorithm for the display window (web page) in referring to the bookmark from the user PC 14 through the Internet. Assume that the bookmarks are managed in units of common advertisement apparatuses by the advertisement DB 12a of the advertisement server 12, as in the advertisement log table 55.

This algorithm creates a bookmark in the frame 81c immediately after a common advertisement apparatus as an advertisement system is selected from the user PC 14 in the frame 81b of the display window 81 as shown in FIG. 25. A description below will be made assuming that the window is displayed on the display 14a when the central control device 31 transfers display data (e.g., an HTML file and the like) to the user PC 14 while the user PC 14 and web server 42 are connected.

First, the central control device 31 transfers to the user PC 14 an HTML which displays a title corresponding to a bookmark and a table title (step S31). The central control device 31 also searches the advertisement log (bookmark) table 55 corresponding to the user PC 14 for records corresponding to the selected system ID and sorts the records in descending order of time (step S32). The records corresponding to the system ID and sorted in the descending order of time are represented by a, and the number of records is represented by b. The central control device 31 defines a variable i and sets 1 (i=1) as the initial value of the variable (step S33).

The central control device 31 searches the advertisement master table 51 for information of an advertisement corresponding to the ith advertisement ID of the records a as search results (step S34). The advertisement information found is represented by c. The central control device 31 compares the variable i with the number (d) of entries of bookmarks which display preset snapshots (step S35).

If i<d, the central control device 31 reads out a snapshot corresponding to the ith record from the advertisement master table 51 and displays the snapshot in the first column. At this time, a URL is discriminated from the presentation site table 52 on the basis of the advertisement ID corresponding to the displayed snapshot and forms a link from the displayed snapshot to the URL (step S36). If i>d, the central control device 31 displays in the first column the time of the ith record out of the records sorted in the descending order of time in step S32 (step S37). The central control device 31 also displays the link to a MailBody and URL corresponding to the ith record in the second column (step S38). Thus, pieces of information corresponding to one bookmark are displayed in the frame 81c.

When the pieces of information corresponding to one bookmark are displayed in the frame 81c, the central control device 31 increments the variable i (i=i+1) (step S39). The central control device 31 compares the incremented variable i with the number b of records (step S40). If the variable i is not larger than the number b of records (i<b), the flow returns to step S34 to repeat the processing. If the variable i is larger than the number b of records (i>b), the central control device 31 displays the footer (character or symbol displayed at the end) of the table (step S41).

Thus, the list of advertisements registered as bookmarks in the common advertisement apparatus selected by the user is displayed on the display 14a of the user PC 14.

As described above, when the bookmark key provided in the common advertisement apparatus is pressed, the advertisement that is being displayed on the display device is registered as a bookmark, and link information linked to a site on the Internet, where a piece of merchandise can be purchased, is displayed on the user PC or portable terminal together with information related to the piece of merchandise of the advertisement registered as the bookmark.

The user can browse the advertisement of his/her interest on the user PC or portable terminal held by the user only by pressing the bookmark key. In addition, to purchase a piece of merchandise, the user can visit the site where the piece of merchandise can be purchased only by selecting the link information.

In the above example, information related to a piece of merchandise registered as a bookmark is displayed on the user PC 14. However, the information related to the piece of merchandise registered as a bookmark may be displayed on the portable terminal 15 having a function of connecting to the Internet.

In this case, to make browsing the information on the display section of the portable terminal easy, a web page for a portable terminal, which corresponds to display on the portable terminal 15, may be created in the web server 42.

With this arrangement, not only the user PC 14 but also a portable terminal such as a portable telephone held by the user can be used to browse the information of bookmarked merchandise, and the merchandise can be purchased only by the portable terminal using the link information.

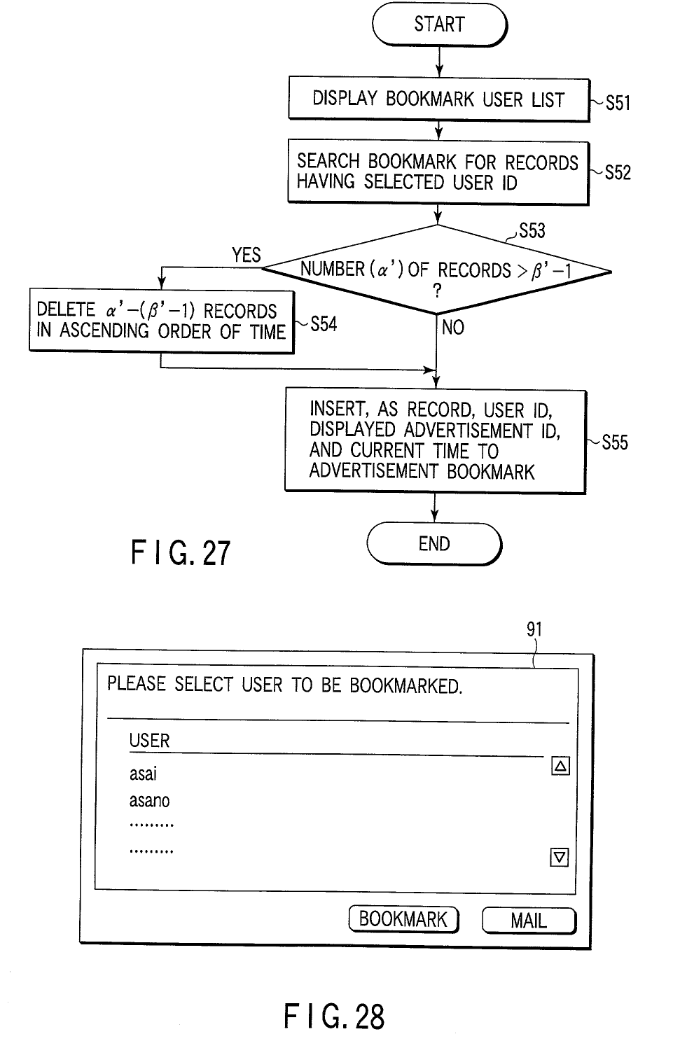

FIG. 27 is a flow chart for explaining operation after the bookmark button 71b is selected in managing the bookmarks in units of users in the common advertisement apparatus.

Assume that the user presses the bookmark button 71b in the advertisement window 71 as shown in FIG. 16. The central control device 31 of the common advertisement apparatus 11 displays, on the LCD 11a, a user selection window 91 for selecting a user to be bookmarked, as shown in FIG. 28 (step S51).

An operation guide and user list are displayed in the user selection window 91. As the operation guide, for example, a user selection guide, “Please select a user to be bookmarked” is displayed. AS the user list, selectable users are displayed on the basis of information registered in the user master table. The user IDs in the bookmark table 65 may be regarded as user names, and a list of user names registered in the bookmark table may be displayed. In this case, for example, the virtual keyboard 75a shown in FIG. 20 is displayed on the LCD 11a to add a user name that is not registered in the bookmark table such that a new user name can be input.

The user selects a user name to be bookmarked in the user selection window 91. The central control device 31 of the common advertisement apparatus 11 searches the bookmark table 65 for all records corresponding to the user ID (step S52).

On the basis of the search result, the central control device 31 discriminates the number (α′) of records having the selected user ID. In the bookmark table 65, the number of records that can be registered as bookmarks is preset for each user ID. This number is represented by β′. In this case, the central control device 31 compares α′ with β−1 on the basis of the number α′ of records and the number β′ of records that can be left as bookmarks (step S53).

If it is determined that the number α′ of records is larger than β′−1 (α′>β′−1) (YES in step S53), the central control device 31 deletes α′−(β′−1) records from the records with the selected user ID in the ascending order of time (step S54).

When the α′−(β′−1) records are deleted in the ascending order of time, or it is determined that the number α′ of records is smaller than β′−1 (α′<β′−1) (NO in step S53), the central control device 31 registers a new record in the bookmark table 65. The user ID, the advertisement ID of the advertisement which is being displayed when the bookmark button is pressed, and the current time are stored in the newly registered record (step S55).

As described above, the web page creation algorithm and web page display example in registering bookmarks for each user in the common advertisement apparatus and referring to the bookmarks from the web can be implemented as in FIGS. 25 and 26 only by changing “for each common advertisement apparatus” to “for each user”.

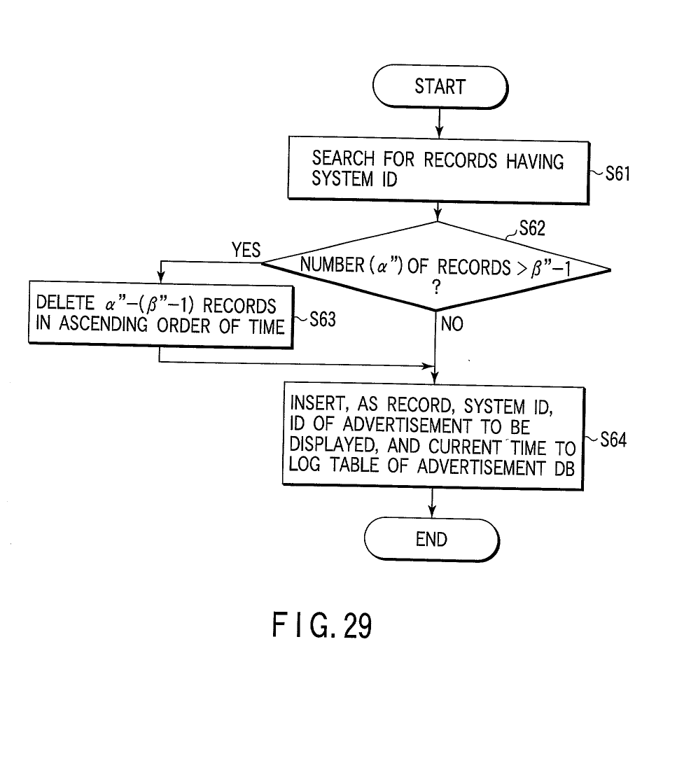

FIG. 29 is a flow chart for explaining an advertisement log management algorithm.

The central control device 31 of the common advertisement apparatus 11 connects to the advertisement server to search the advertisement log table 55 of the advertisement DB 12a for records having the system ID of the common advertisement apparatus (step S61).

On the basis of the search result, the central control device 31 discriminates the number (α″) of records with the system ID of the common advertisement apparatus 11. In the advertisement log table 55 of the advertisement DB 12a, the number of records that can be registered as bookmarks is preset for each system ID. This number is represented by β″. In this case, the central control device 31 compares α″ with β″−1 on the basis of the number α″ of records and the number β″ of records that can be left as bookmarks (step S62).

If it is determined that the number α″ of records is larger than β″−1 (α″>β″−1) (YES in step S62), the central control device 31 deletes α″−(β″−1) records from the records with the system ID of the common advertisement apparatus in the ascending order of time (step S63).

When the α″−(β″−1) records are deleted in the ascending order of time, or it is determined that the number α″ of records is smaller than β″−1 (α″<β″−1) (NO in step S62), the central control device 31 registers a new record in the advertisement log table 55. The system ID, the advertisement ID of the advertisement to be displayed, and the current time are stored in the newly registered record (step S64).

As described above, the web page creation algorithm and web page display example in registering the log of advertisements to be displayed on the common advertisement apparatus and referring to the registered advertisement log from the web can be implemented as in FIGS. 25 and 26 only by changing “bookmark” to “advertisement log”.

A case wherein a piece of merchandise is purchased using link information (URL) in an e-mail message or a bookmark will be described next.

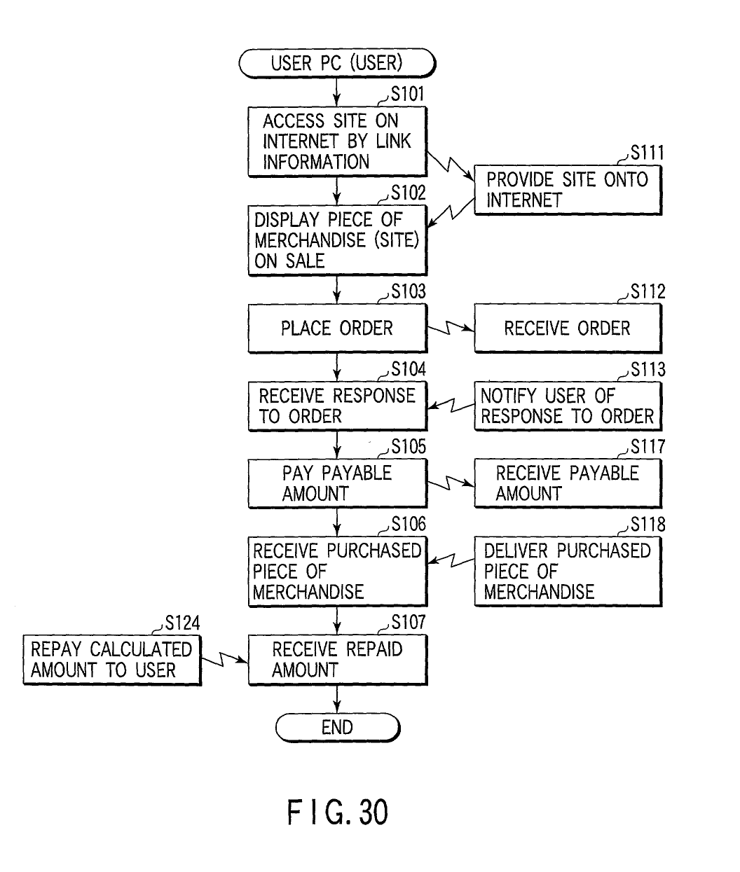

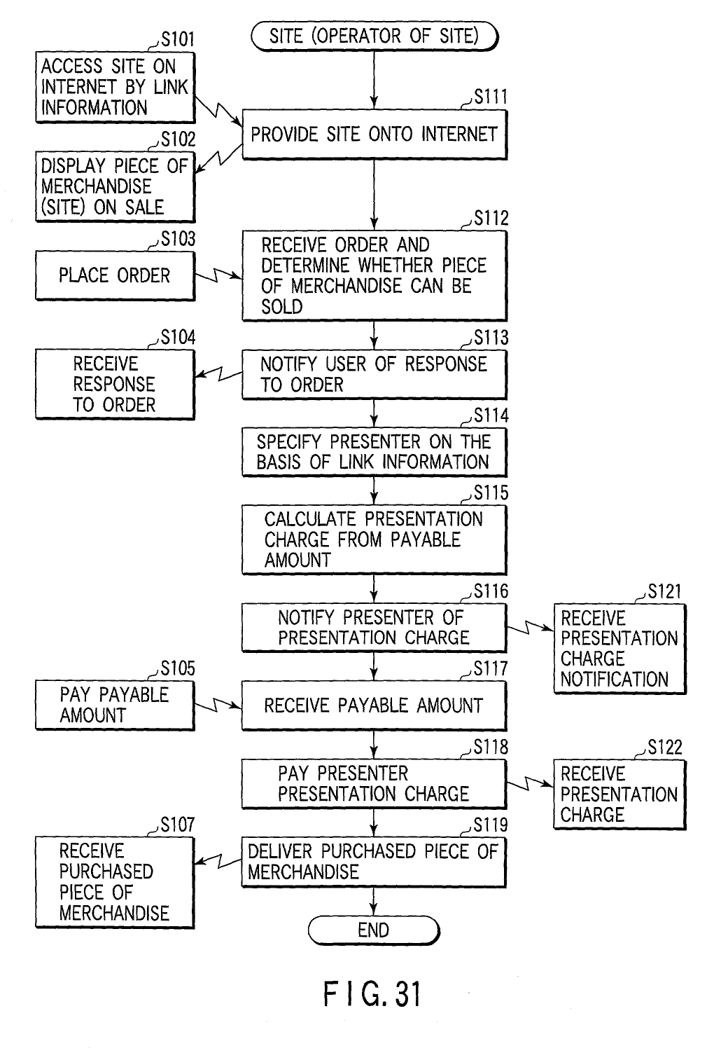

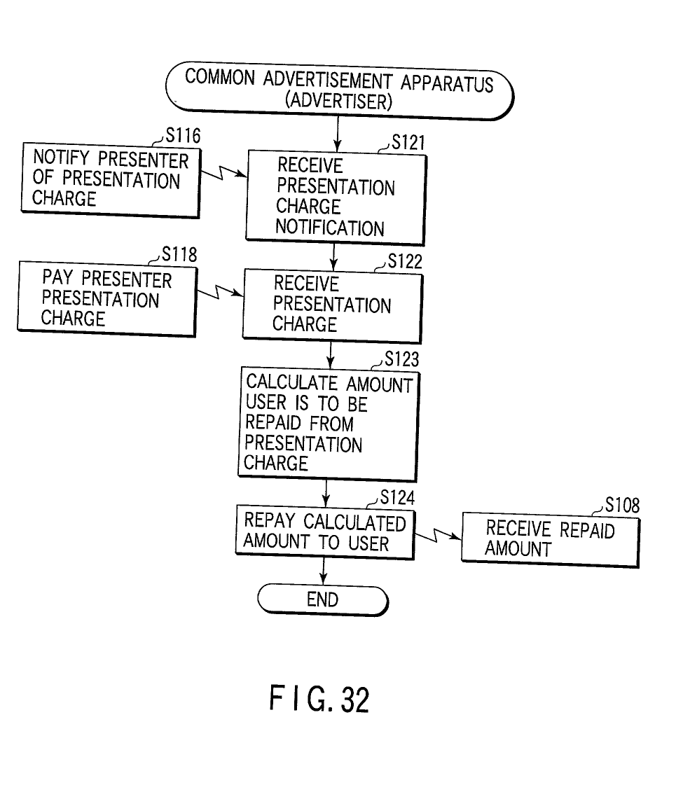

FIGS. 30 to 32 are flow charts for explaining operations when a piece of merchandise is purchased using link information in an e-mail message or a bookmark provided from the common advertisement apparatus 11. FIG. 30 is a flow chart for explaining user-side operation. FIG. 31 is a flow chart for explaining operation on the side of the site (electronic store in the electronic mall) 13a that sells merchandise on the Internet. FIG. 32 is a flow chart for explaining operation on the side of the common advertisement apparatus 11 as an advertisement presenter.

The user-side operation will be described first with reference to the flow chart shown in FIG. 30. A case wherein an e-mail message transmitted from the common advertisement apparatus 11 is received by the user PC, and a piece of merchandise is purchased will be described here. The user-side operation when a piece of merchandise is purchased using the link information of a bookmark is the same as that when a piece of merchandise is purchased by a portable terminal such as a portable telephone having the Internet connection function.

Assume that the user causes the user PC 14 to display an e-mail message from the common advertisement apparatus 11. Link information to the site where a piece of merchandise is on sale is displayed on the display 14a as the contents of the e-mail message together with information related to the piece of merchandise. When the user selects the link information, the user PC 14 connects to the Internet to access the site 13a represented by the link information (step S101). When the access to the site 13a is complete, the site 13a where the information of the piece of merchandise is presented is displayed on the display 14a of the user PC 14 (step S102).

Assume that the user wants to purchase the piece of merchandise upon browsing the site 13a displayed on the display 14a. The user inputs order information, e.g., data for user authentication, charge payment method, and the like through the user PC 14a and transmits the information to the site 13a side (step S103). As will be described later, on the site 13a side, user authentication and check of the piece of merchandise stock are done on the basis of the order information from the user PC 14, and it is determined whether the piece of merchandise can be sold. A response message from the site 13a based on this determination is received by the user PC 14 (step S104). For example, when the site 13a side determines that the piece of merchandise can be sold, the user PC 14 receives a notification that the order has been accepted. If the site 13a side determines that the piece of merchandise cannot be sold, the user PC 14 receives a notification that the piece of merchandise cannot be sold.

Upon receiving the notification that the order has been accepted from the site 13a side, the user pays the charge for the piece of merchandise by the payment method of user's choice or the payment method designated on the site 13a side (step S105). After the payment is confirmed on the site 13a side, the piece of merchandise is delivered, and the user receives the piece of merchandise (step S107). In addition, the user is paid a predetermined amount corresponding to the paid amount from the common advertisement apparatus 11 side as a merchandise presenter. The user receives the predetermined amount corresponding to the charge for the piece of merchandise from the common advertisement apparatus 11 side (step S108).

In the above example, the common advertisement apparatus 11 side repays the user the presentation charge as a cash back. However, the user may be partially repaid the presentation charge by discounting the payable amount in selling the piece of merchandise. Alternatively, instead of the cash back, the user may be repaid merchandise or service by using the presentation charge as financial resources.

The operation on the side of the site 13a which sells merchandise on the Internet will be described next with reference to the flow chart shown in FIG. 31.

The site 13a opened in the electronic mall 13 provides a window where merchandise can be purchased on the Internet (step S111). For example, when the user PC 14 accesses the site using link information, as in step S101 above, the site 13a transmits the display data of the window where merchandise is on sale to the user PC 14. With this processing, the site 13a is displayed on the display 14a of the user PC 14, as in step S102.

Assume that an order for a piece of merchandise is sent from the user PC 14 to the site 13a. The site 13a receives the merchandise order information and performs user authentication, check of the payment method, and check of the piece of merchandise stock on the basis of the order information. The site 13a side determines whether the piece of merchandise can be sold (step S112).

On the basis of the determination, the site 13a transmits a response to the order for the piece of merchandise to the user PC 14 (step S113). For example, when it is determined that the piece of merchandise can be sold, the site 13a side notifies the user PC 14 that the order has been accepted. If it is determined that the piece of merchandise cannot be sold, the site 13a side notifies the user that the piece of merchandise cannot be sold.

When the order for the piece of merchandise is accepted by the above determination, the site 13a specifies the presenter on the basis of the link information used by the user PC 14a for the access. A case wherein the common advertisement apparatus 11 is specified as the presenter will be described here. When the common advertisement apparatus 11 is specified as the presenter, the site 13a calculates the presentation charge corresponding to the payable amount (step S114). The presentation charge to be calculated here is calculated on the basis of a predetermined agreement with the presenter. The site 13a that has calculated the presentation charge notifies the common advertisement apparatus 11 as the presenter of the calculated presentation charge and buyer information (step S116).

After that, when the payable amount for the piece of merchandise is received from the buyer (step S117), the site 13a pays the presenter the presentation charge calculated in step S115 (step S118). The operator of the site 13a, who has confirmed the payment of the payable amount from the buyer, delivers the piece of merchandise to the buyer, and the transaction is ended (step S118).

The operation on the common advertisement apparatus 11 side will be described next with reference to the flow chart shown in FIG. 32.

Assume that the piece of merchandise presented to the user by an e-mail message or bookmark is actually purchased. A presentation charge notification is sent from the site 13a where the piece of merchandise is on sale to the common advertisement apparatus 11, as in step S116 above. Operation of the common advertisement apparatus 11 as an advertisement presenter will be described below. This also applies to operation of the server 12 of the advertiser as an advertisement presenter.

Upon receiving the presentation charge notification from the site 13a (step S121), the common advertisement apparatus 11 specifies the buyer on the basis of buyer information transmitted from the site 13a together with the presentation charge and stores the buyer in a memory (not shown). After that, when the presentation charge is paid by the site 13a, the common advertisement apparatus 11 confirms the payment of the presentation charge (step S122). The common advertisement apparatus 11 confirms the payment of the presentation charge and then calculates an amount the buyer is to be repaid from the presentation charge (step S123). The common advertisement apparatus 11 repays the buyer the calculated amount (step S124), and the processing is ended.

A system which pays the presenter the presentation charge when a piece of merchandise is sold by a presentation mail message as described above is added, and the user is partially repaid the presentation charge by discounting the amount or cash back. With this arrangement, the operator of the common advertisement apparatus can obtain ad revenues. For the user, the motivation for a piece of merchandise purchase can be made stronger, and the will to purchase the piece of merchandise can be improved.

That is, when the presentation charge for sale of the piece of merchandise presented by the common advertisement apparatus is received, a predetermined amount corresponding to the presentation charge is repaid to the user. It is advantageous for the user because the amount corresponding to the payable amount is repaid when he/she purchases the piece of merchandise presented by the common advertisement apparatus.

In the above example, the user is repaid the amount on the basis of the presentation charge after the presentation charge is received. However, when the presentation charge notification is received in step S116, the site may be notified of the amount the user is to be repaid and discount the payable amount itself. In this case, the site 13a receives the discount amount notification from the common advertisement apparatus and then notifies the buyer of the payable amount. When the payable amount is discounted, the common advertisement apparatus need not take time to repay the buyer after the reception of the presentation charge.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An advertisement system which provides an advertisement of merchandise to a number of users, comprising:
a display device for displaying the advertisement of merchandise;
a mail button for instructing to transmit, by an e-mail message, information related to the piece of merchandise of the advertisement displayed by said display device;
an input device for inputting a recipient of the e-mail message for which transmission is instructed by said mail button; and
a mail transmission device for, when said mail button is pressed, transmitting the e-mail message having the information of the piece of merchandise, including link information linked with a site on the Internet where the piece of merchandise is on sale, to the recipient input by said input device.

2. An advertisement system according to claim 1, wherein
said system further comprises a connection device connected to a network, and
said mail transmission device has a function of connecting to the network and transmits the e-mail message having the information of the piece of merchandise, including the link information linked with the site on the Internet where the piece of merchandise is on sale, to a mail address on the network, which is input by said input device.

3. An advertisement system according to claim 1, wherein said mail transmission device is a radio communication module for performing short-distance radio communication and connects to a portable terminal designated by said input device and connectable by short-distance radio communication to transmit the e-mail message having the information of the piece of merchandise, including the link information linked with the site on the Internet where the piece of merchandise is on sale, to the portable terminal.

4. An advertisement system according to claim 1, wherein
said system further comprises a memory in which an address capable of receiving an e-mail message is registered in advance for each user, and
said input device causes a user to select an address to which the e-mail message is to be transmitted from a list of users registered in said memory in advance.

5. An advertisement system according to claim 1, wherein
said system further comprises a memory for storing, as a transmission log, an address for an e-mail message transmitted by said mail transmission device, and
said input device causes a user to select an address to which the e-mail message is to be transmitted from a list of transmission logs registered in said memory.

6. An advertisement system according to claim 1, wherein
said system further comprises a memory for storing a plurality of types of forms of an e-mail message to be transmitted by said mail transmission device,
said input device causes a user to select a form of the e-mail message to be transmitted from the forms stored in said memory, and
said mail transmission device generates the e-mail message having the information of the piece of merchandise, including the link information linked with the site on the Internet where the piece of merchandise is on sale, using the form selected by said input device and transmits the e-mail message.

7. An advertisement system according to claim 6, wherein
said memory stores at least a form for requesting a buyer who has an authority for purchase to purchase the piece of merchandise as one of the forms, and
when the form for requesting purchase of the piece of merchandise is selected by said input device, said mail transmission device transmits the e-mail message having the information of the piece of merchandise, including link information linked with a site on the Internet where the piece of merchandise is on sale, to the recipient input by said input device using the form for requesting the buyer to purchase the piece of merchandise.

8. An advertisement system according to claim 1, wherein
said system further comprises a memory in which permission/inhibition of display of the advertisement displayed on said device is set in accordance with a category of the piece of advertised merchandise or a time zone for display, and
said device displays the advertisement of the piece of merchandise on the basis of the permission/inhibition of display set in said memory.

9. An advertisement system according to claim 1, wherein the link information contains information representing a presenter of the piece of merchandise.

10. An advertisement system which provides an advertisement of merchandise to a number of users, comprising:
a display device for displaying the advertisement of merchandise;
a memory for storing, as a bookmark, information related to the piece of merchandise displayed by said device;
a registration button for registering the information related to the piece of merchandise as the bookmark when the advertisement of the piece of merchandise is being displayed on said device; and
a server device for, upon being accessed from an external device, transmitting the information related to the piece of merchandise registered in said memory as the bookmark to the external device as data displayable on the external device, the data displayable on the external device containing link information linked with a site on the Internet where the piece of merchandise is on sale.

11. An advertisement system according to claim 10, wherein the link information contains information representing a presenter of the piece of merchandise.

12. An advertisement system according to claim 10, wherein said server device has a function of connecting to a network and is accessed from the external device through the network.

13. An advertisement system according to claim 10, wherein the external device is a portable terminal capable of short-distance radio communication, and
said server device has a function of performing short-distance radio communication and is accessed from said portable terminal by short-distance radio communication.

14. An advertisement system according to claim 10, wherein said server device is a WWW server for providing contents onto the Internet and is accessed from the external device by the WWW.

15. An advertisement system according to claim 10, wherein
said memory stores the information related to the piece of merchandise as the bookmark in units of systems, and
for a user who has accessed said server by the external device, said server transmits the information related to the piece of merchandise registered as the bookmark corresponding to said system to the external device as the data displayable on the external device.

16. An advertisement system according to claim 10, wherein
said memory stores the information related to the piece of merchandise as the bookmark in units of users, and
said server identifies a user who has accessed said server by the external device and transmits the information related to the piece of merchandise registered as the bookmark corresponding to the user to the external device as the data displayable on the external device.

17. An advertisement system which provides an advertisement of merchandise to be sold on the Internet to a number of users, comprising:
a display device for displaying the advertisement of merchandise;
a mail button for instructing to transmit, by an e-mail message, information related to the piece of merchandise of the advertisement displayed by said display device;
an input device for inputting a recipient of the e-mail message for which transmission is instructed by said mail button; and
a mail transmission device for, when said mail button is pressed, transmitting the e-mail message having the information of the piece of merchandise, including link information linked with a site on the Internet where the piece of merchandise is on sale, to the recipient designated by said input device, the link information containing information representing a presenter of the piece of merchandise,
wherein when the piece of merchandise is purchased at the site on the Internet linked by the link information, a service corresponding to a payable amount for the piece of merchandise is provided to a buyer.

18. An advertisement system according to claim 17, wherein the service provided to the buyer is discount or cash back of an amount corresponding to the payable amount.

19. An advertisement system according to claim 17, wherein the service provided to the buyer is to partially repay the buyer a presentation charge paid to the presenter specified by the link information.

20. An advertisement system which provides an advertisement of merchandise provides an advertisement of merchandise to be sold on the Internet to a number of users, comprising:
a display device for displaying the advertisement of merchandise;
a memory for storing, as a bookmark, information related to the piece of merchandise displayed by said device;
a registration button for registering the information related to the piece of merchandise as the bookmark when the advertisement of the piece of merchandise is being displayed on said device; and
a server device for, upon being accessed from an external device, transmitting the information related to the piece of merchandise registered in said memory as the bookmark to the external device as data displayable on the external device, the data displayable on the external device containing link information linked with a site on the Internet where the piece of merchandise is on sale, the link information containing information representing a presenter of the piece of merchandise,
wherein when the piece of merchandise is purchased at the site on the Internet linked by the link information, a service corresponding to a payable amount for the piece of merchandise is provided to a buyer.

21. An advertisement system according to claim 20, wherein the service provided to the buyer is discount or cash back of an amount corresponding to the payable amount.

22. An advertisement system according to claim 20, wherein the service provided to the buyer is to partially repay the buyer a presentation charge paid to the presenter specified by the link information.

23. An advertisement method of providing an advertisement of merchandise to be sold on the Internet, comprising:
the first step of designating to transmit, by an e-mail message, information related to the piece of merchandise of the advertisement displayed on a display device usable by a number of users;
the second step of designating a recipient of the e-mail message for which transmission is designated in the first step;
the third step of, when transmission of the e-mail message is designated in the first step, transmitting the e-mail message having the information of the piece of merchandise, including link information linked with a site on the Internet where the piece of merchandise is on sale, to the recipient designated in the second step, the link information containing information representing a presenter of the piece of merchandise; and
the fourth step of, when the piece of merchandise is purchased at the site on the Internet by the e-mail message transmitted in the third step, specifying the presenter by the link information and providing a service corresponding to a payable amount for the piece of merchandise to a buyer.

24. An advertisement method according to claim 23, wherein the service provided to the buyer in the fourth step is discount or cash back of an amount corresponding to the payable amount.

25. An advertisement method according to claim 23, wherein the service provided to the buyer in the fourth step is to partially repay the buyer a presentation charge paid to the presenter specified by the link information.

26. An advertisement method of providing an advertisement of merchandise provides an advertisement of merchandise to be sold on the Internet, comprising:
the first step of storing, as a bookmark, information related to the piece of merchandise displayed on a device usable by a number of users in a memory;
the second step of, in accordance with an access from an external device, transmitting the information related to the piece of merchandise registered in the memory as the bookmark in the first step to the external device as data displayable on the external device, the data displayable on the external device containing link information linked with a site on the Internet where the piece of merchandise is on sale, and the link information containing information representing a presenter of the piece of merchandise; and
the third step of, when the piece of merchandise is purchased at the site on the Internet linked by the link information of the bookmark displayed on the external device by the data transmitted in the second step, providing a service corresponding to a payable amount for the piece of merchandise to a buyer.

27. An advertisement method according to claim 26, wherein the service provided to the buyer in the third step is discount or cash back of an amount corresponding to the payable amount.

28. An advertisement method according to claim 26, wherein the service provided to the buyer in the third step is to partially repay the buyer a presentation charge paid to the presenter specified by the link information.
